(19) United States
(12) Patent Application Publication
(10) Pub. No.: US 2024/0280702 A1
(43) Pub. Date: Aug. 22, 2024

(54) SYSTEM FOR TRACKING CONVEYED OBJECTS

(71) Applicant: Laitram, L.L.C., Harahan, LA (US)

(72) Inventors: Sven-Erik Haitjema, Koog aan de Zaan (NL); Yorrick Mulder, Baltimore, MD (US)

(21) Appl. No.: 18/571,921

(22) PCT Filed: Jun. 24, 2022
(86) PCT No.: PCT/US2022/034894

§ 371 Date: Dec. 19, 2023

Related U.S. Application Data
(60) Provisional application No. 63/227,047, filed on Jul. 29, 2021.

(51) Int. Cl. G01S 17/89; G01S 7/48; G01S 17/58

(52) U.S. Cl. CPC G01S 17/89; G01S 7/4802; G01S 17/58

(57) ABSTRACT

A tracking system using a rangefinder, such as a Lidar sensor, to track objects conveyed on a belt conveyor. The rangefinder produces depth frames in a field of view encompassing a portion of a conveyor. The depth frames comprise an array of pixels whose values represent distances from the rangefinder to reflective surfaces in the field of view. The rectangular reflection surfaces of objects are identified and their dimensions and centroids are calculated so that the objects can be tracked from frame to frame. An object's trajectory angle Θi is computed and stored in a tracking buffer array. Conventional smoothing techniques can be used to convert the piecewise linear trajectory (30) into a smooth curved trajectory. If an object is being conveyed on a conveyor belt without slipping on the belt's surface, its component of velocity vₓ in the x direction can be used as an estimate of the speed of the conveyor belt. The orientation of the object can be tracked from frame to frame to reveal whether the conveyor belt is changing the object's orientation relative to the conveying direction.

### BACKGROUND

The invention relates generally to power-driven conveyors and more particularly to using rangefinders to identify and track conveyed objects.

Optical means are often used to identify and track objects conveyed on conveyors. But the effectiveness of optical detection depends on the illumination of the objects. Faint or overly bright illumination can degrade performance.

### SUMMARY

A tracking system embodying features of the invention comprises a conveyor conveying objects in a conveying direction on a conveying surface and a rangefinder disposed above the conveyor and scanning a field of view encompassing a portion of the conveyor. At a predetermined repetition rate, the rangefinder captures depth frames constituting an array of pixels whose values indicate the distance from the rangefinder to objects in the field of view. A processing system executes program instructions to:
a) determine the position on the conveyor of a selected tracking point on each of the objects;
b) track the selected point of each of the objects from depth frame to depth frame to map the trajectory of each of the objects along the conveyor; and c) determine one or more motion characteristics of the object from the trajectory.

A method for tracking objects comprises: (1) conveying objects in a conveying direction on a conveying surface of a conveyor; (2) capturing, with a rangefinder, depth frames constituting an array of pixels whose values indicate the distance from the rangefinder to objects in a field of view encompassing a portion of the conveyor; executing program instructions by a processing system to: a) determine the position on the conveyor of a selected tracking point on each of the objects; b) track the selected tracking point of each of the objects from depth frame to depth frame; c) map the trajectory of each of the objects along the conveyor from the depth frames; and d) determine one or more motion characteristics of each of the objects from the trajectory.

### BRIEF DESCRIPTION OF THE DRAWINGS

FIG. 1 is a side elevation view of a tracking system using a rangefinder to identify and track conveyed objects.

FIGS. 2A and 2B are top plan views of the system of FIG. 1 at two different times.

FIG. 3 is a flowchart of an exemplary set of program steps executed by a processing system in the tracking system of FIG. 1.

FIG. 4 is a table representing the structure of a tracking buffer used by the processing system in the tracking system of FIG. 1 to store characteristics of motion of conveyed objects.

FIG. 5 is a flowchart of program steps executed by the processing system to compute the characteristics of motion of conveyed objects and store them in the buffer of FIG. 4.

FIG. 6 is a top plan view as in in FIGS. 2A and 2B showing how object trajectories are computed.

### DETAILED DESCRIPTION

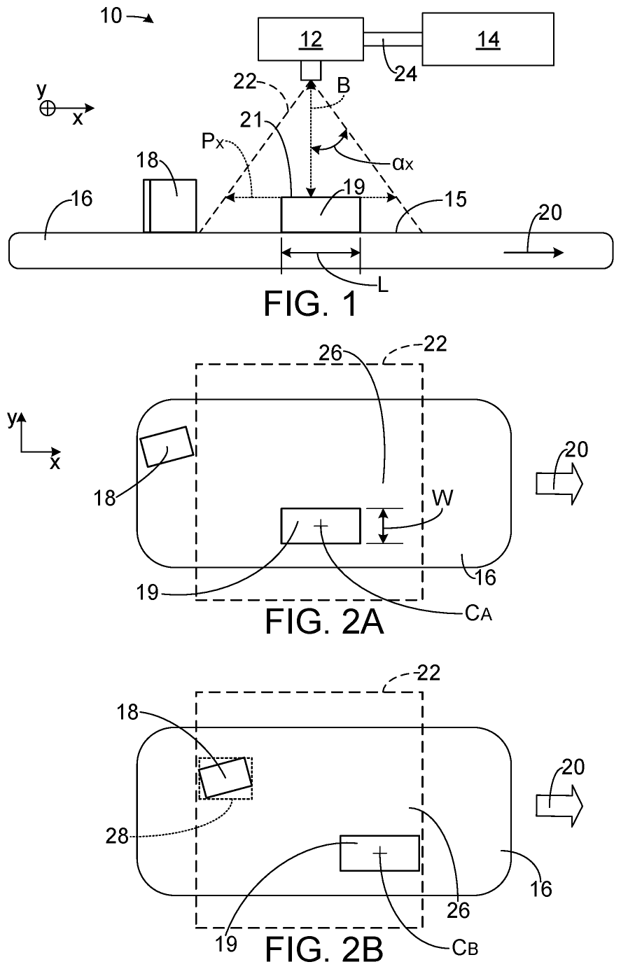

A tracking system embodying features of the invention is shown in FIG. 1. The system 10 comprises a rangefinder, such as a Lidar sensor 12, which measures distances to a target, and a programmable processing system 14, which may be realized as a conventional processor and a graphical processing unit. A time-of-flight (TOF) sensor is an example of another suitable rangefinder, but the Lidar sensor will be used as the example rangefinder throughout the description. The Lidar sensor 12 produces depth frames, each composed of an array of distance, or depth, measurements from the sensor to objects in the sensor's field of view 22.

The Lidar sensor 12 is aimed at a portion of a conveyor 16, such as a belt conveyor, conveying objects, such as objects 18, 19, in a conveying direction 20. As also indicated in FIGS. 2A and 2B, a laser in the Lidar sensor 12 scans the field of view 22, which covers a portion of the conveyor 16. The laser directs pulses of laser light in a pattern of discrete directions that define the field of view 22. Reflections of the laser light pulses off the tops of the objects 18, 19 are detected by the Lidar sensor 12. The interval between the transmission of each pulse and the reception of its reflection is the two-way time of flight (TOF), which is proportional to the distance of the Lidar sensor 12 from a reflecting surface in that direction. Thus, each scan of the Lidar sensor's laser produces a frame of distance, or depth, measurements to whatever is in the field of view 22. And, unlike RGB cameras and other optical devices that require proper illumination, the depth-measuring Lidar sensor 12 does not. The Lidar sensor 12 sends the depth frame to a programmable processing system 14 over a communication link or data bus 24 (FIG. 1). The depth frame is composed of a two-dimensional (x and y) array of pixels whose values correspond to the distance, or depth, measurements covering the field of view 22.

Before operating the object-tracking system, the distance from the sensor 12 to the upper surface 15 of the conveyor 16 is measured. The tilt of the sensor in both the x and the y directions is also measured. The measurements may be made manually or automatically. The measurements are manually entered into or automatically sent to the programmable processing system 14.

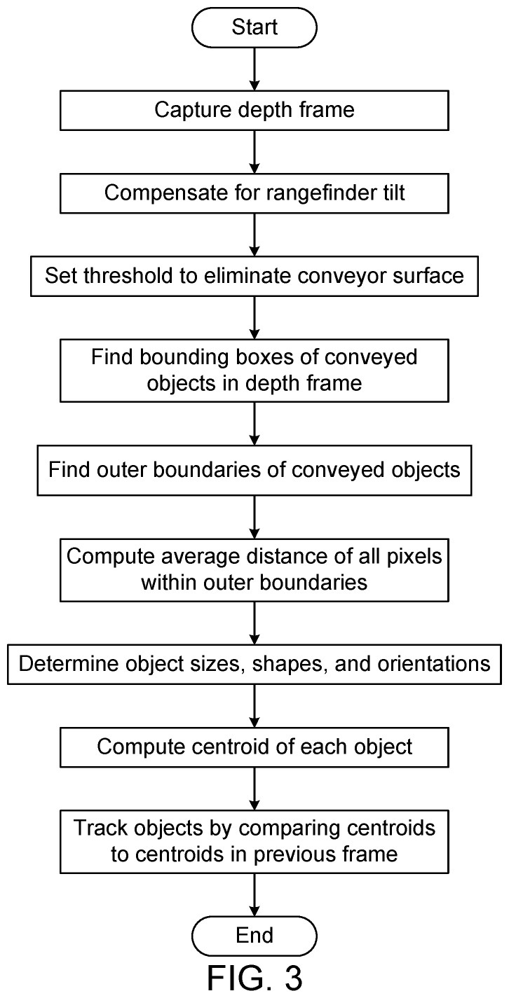

A flowchart describing the processing steps programmed into program memory and executed by a processor in the Lidar sensor 12 or by the external processing system 14 is shown in FIG. 3 as it applies to FIGS. 1, 2A, and 2B. The sequence of programming steps shown in the flowchart and executed by the processing system is repeated at a regular repetition rate that is fast enough to keep up with the conveying speed to allow individual objects to be tracked as they advance through the field of view 22.

First, the Lidar sensor 12 captures a depth frame covering the field of view 22. The processing system 14 corrects the measurement values at each pixel to compensate for the tilt of the Lidar sensor 12 in both the x and y directions by using the measured tilt values. A depth threshold is set based on the measured distance from the sensor 12 to the top conveying surface 15 of the conveyor 16 to eliminate pixels representing the conveyor and other distant structures in the field of view 22 from the depth frame. The remaining pixels include nearer structures, such as objects atop the conveyor. Next, the processing system 14 finds bounding boxes 28 (FIG. 2B). The bounding boxes used 28 in this example are rectangular with sides parallel to the x and y directions. Each bounding box 28 encompasses groups of contiguous pixels all of whose values in the depth frame are within a predetermined range. The bounding boxes circumscribe the outer boundaries of objects on the conveyor 16 present in the depth frame.

To find the bounding boxes 28, the processing system 14 first erodes the pixels in the depth frame by sliding a structuring element, or kernel, such as a three-by-three pixel array over the depth frame from pixel to pixel. At each pixel, the minimum pixel value in the array is assigned to the pixel being eroded. The effect is to reduce noise “specks” in the depth frame. After eroding the depth frame, the processing system 14 then dilutes the pixels by sliding a similar kernel through the depth frame. In dilution the maximum value of the pixels in the kernel is assigned to the pixel being diluted. Dilution has the effect of closing pixel shapes so that the outside boundaries can be more easily found.

Once the bounding boxes 28 of objects in the depth frame are found, the processing system 14 finds the outer boundaries of the objects within the bounding boxes and eliminates those pixels between the outer boundaries and the bounding boxes from the images of the objects. The processing system 14 then computes an average distance of all the pixels within each outer boundary. The average distance is then assigned to each pixel within (including on) the outside boundary. All the pixels are given equal values because they represent the top faces of objects facing the Lidar sensor 12, and so are equidistant from the sensor if the objects have parallel top and bottom faces. And the equal values make the subsequent computation of the centroid of the top face more accurate. Then the programmable processing system 14, from the outside boundary, determines the size, shape, and orientation of each object in the field of view.

The size of an object is calculated by reference to FIG. 1 for rectangular objects oriented with their axes in the x and y direction. First, the length (in the x direction; i.e., the conveying direction) and the width (in the y direction; i.e., the transverse direction perpendicular to the conveying direction in a plane parallel to the plane of the conveying surface) of a plane containing the top face 21 of the object 19 is determined. For example, the plane's length, Pₓ, as shown in FIG. 1, is given by Pₓ=(B/2)tan(αₓ), where B is the average distance from the Lidar sensor 12 to the top face of the object 19 and αₓ is half the maximum sweep angle of the Lidar sensor in the x direction. A similar calculation is made in the y direction for the plane's width P_{y}=(B/2)tan(α_{y}), where α_{y} is half the maximum sweep angle of the Lidar sensor in the y direction. Because of the Lidar sensor's sweep angle, the pixel-to-pixel distance increases with distance from the sensor. So a shorter object with the same top surface area as a taller object appears smaller because it spans fewer pixels.

The dimensions of the rectangular object 19 (length L in the x direction and width W in the y direction), whose axes are parallel to the x and y directions, are determined as follows: L=Pₓ·(the number of pixels lying within the outside boundary in the x direction along a line in the x direction)/(Lidar sensor frame length in pixels); and W=P_{y}·(the number of pixels lying within the outside boundary in the y direction along a line in the x direction)/(Lidar sensor frame width in pixels). The number of pixels lying within the outside boundary along a line in the x or y direction is determined by the number of pixels lying within the outside boundary along a row or column of the pixel array of the depth frame. For objects oriented oblique to the x and y directions, such as the object 18 (FIG. 2A), the processing system 14 finds the orientation angle from the outer boundaries and computes the lengths and widths accordingly. For non-rectangular objects, such as circular, oval, or other polygonal objects, corresponding geometric relationships are used to determine their dimensions. If the shape does not match an acceptable shape or the dimensions exceed predetermined maximum dimensions, the processing system 14 optionally flags an unrecognized or oversized object condition, which could indicate abutting or overlapping objects or unauthorized objects. Remedial action can then be taken.

Once the lengths and widths of the individual objects in the depth frame are calculated, the processing system then computes the centroid (C_{B}, FIG. 2B) of the top face of each object 19 and its position projected onto the surface of the conveyor. Points on the object other than the centroid could be selected as the tracking point. For example, one of the corners of the object or a point on the leading boundary and the major axis could be used as the tracking point. In the following description, the centroid is used as the exemplary tracking point. The processing system tracks the centroid C_{B} or other selected point of each object 19 by comparing its change in position from the current frame to the position of the centroid (C_{A}, FIG. 2A) or the other selected point in the previous frame. In this way, each object's progress along the conveyor is mapped. The object positions from frame to frame are saved in data memory in a dedicated tracking buffer array for each of the identified objects. Only if the change in position of the centroid is less than a predetermined number of pixels from its position in the previous frame is the tracking data for each object updated. If the position of a centroid exceeds that predetermined number of pixels, the associated object (18, FIG. 2B) is considered to be an object that has first been conveyed into the field of view, and its position is entered into its dedicated tracking buffer array. The process described repeats for the next frames at the repetition rate.

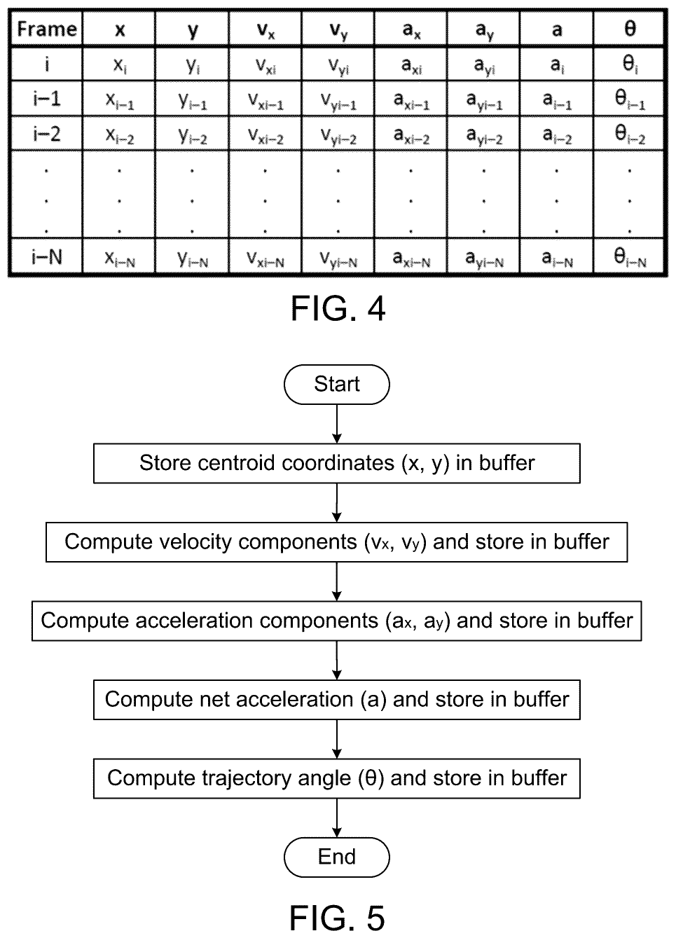

An example of a tracking buffer array for a conveyed object is shown in FIG. 4. Each buffer consists of up to eight values defining the array's width for each frame indicating various characteristics of the motion of the object: (1) x (coordinate of the centroid in the conveying direction; (2) y (coordinate of the centroid in the transverse direction; (3) vₓ (x component of the object's velocity); (4) v_{y} (y component of the object's velocity); (5) aₓ (x component of the object's acceleration); (6) a_{y} (y component of the object's acceleration); (7) a (net acceleration of the object); and (8) θ (trajectory angle of the object). The array's length is set by the number of frames (N+1) that are to be saved. At least two frames (N=1) are necessary. The buffer array can be a circular buffer array in which the oldest entry is replaced by the most recent by using a modulo N+1 pointer.

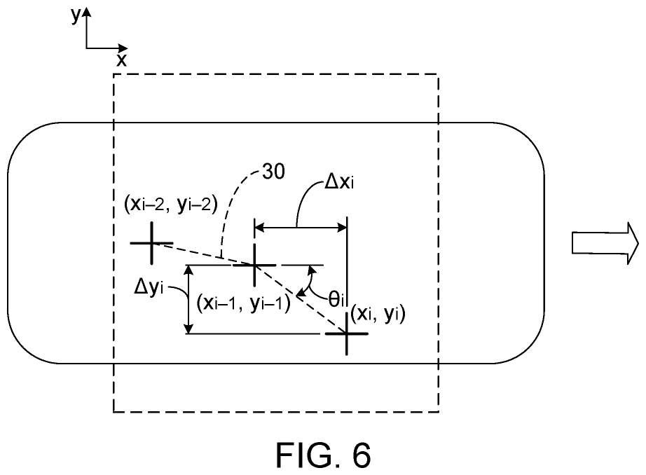

FIG. 5 is a flowchart representing steps in program memory executed by the processing system for each frame to track each object. FIG. 6 provides an example of the position of an object's centroid (indicated by the crosses) in three consecutive depth frames. The centroids are shown in FIG. 6 following a trajectory that changes in both x and y from frame to frame. Such a trajectory is what would be expected in a sorting or alignment conveyor, for example, in which objects are diverted transversely while being conveyed in the conveying direction.

Once the centroid has been computed, its x and y coordinates xᵢ and yᵢ are stored in the tracking buffer array, where the subscript i indicates the current depth frame. The processing system computes the two components of the object's velocity: vₓᵢ=(xᵢ−xᵢ₋₁)/T and v_{yi}=(yᵢ−yᵢ₋₁)/T, where the subscript i−1 refers to the previous depth frame and T is the interval between consecutive frames. The computed values vₓ and v_{y} are stored in the buffer array and are used to compute the two components of acceleration: aₓᵢ=(vₓᵢ−vₓᵢ₋₁)/T and a_{yi}=(v_{yi}−v_{yi-1})/T. Those values are then stored in the tracking buffer array. The processing system then computes the net, or magnitude of, acceleration: aᵢ=(aₓᵢ²+a_{yi}²)^{1/2}. The net acceleration aᵢ is then stored in the tracking buffer array. Finally, the object's trajectory angle is computed as shown geometrically in FIG. 6: θᵢ=arctan(Δyᵢ/Δxᵢ), where Δyᵢ=yᵢ−yᵢ₋₁ and Δxᵢ=xᵢ−xᵢ₋₁. The trajectory angle θᵢ is stored in the tracking buffer array. Low-pass digital filtering may be applied to some or all of these values to lessen the effects of noise. Filtered values could be added to the buffer array. And the kind of digital filtering employed—finite impulse response (FIR) or infinite impulse response (IIR)-dictates the length (N−1) of the buffer array necessary to retain older values needed to achieve the desired filtering. Conventional smoothing techniques can be used to convert the piecewise linear trajectory 30 of FIG. 6 into a smooth curved trajectory.

If an object is being conveyed on a conveyor belt without slipping on the belt's surface, its component of velocity vₓ in the x direction can be used as an estimate of the speed of the conveyor belt. And the orientation of the object can be tracked from frame to frame to reveal whether the conveyor belt is changing the object's orientation relative to the conveying direction, for instance.

1. A tracking system comprising:
a conveyor conveying objects in a conveying direction on a conveying surface;
a rangefinder disposed above the conveyor scanning a field of view encompassing a portion of the conveyor at a predetermined repetition rate to capture depth frames constituting an array of pixels whose values indicate the distance from the rangefinder to objects in the field of view;
a processing system executing program instructions to:
a) determine the position on the conveyor of a selected tracking point on each of the objects;
b) track the selected tracking point of each of the objects from depth frame to depth frame to map the trajectory of each of the objects along the conveyor; and
c) determine one or more motion characteristics of the object from the trajectory.

2. The tracking system as claimed in claim 1 wherein the processing system executes program instructions to compensate the depth frame for tilt of the rangefinder with respect to the conveyor.

3. The tracking system as claimed in claim 1 wherein the processing system executes program instructions to erode and dilute dilate the pixels in each depth frame before determining outer boundaries of the objects.

4. The tracking system as claimed in claim 1 wherein the processing system executes program instructions to set a depth threshold above the conveying surface to eliminate the conveying surface and structures farther from the rangefinder from appearing in the depth frames.

5. The tracking system as claimed in claim 1 wherein the processing system executes program instructions to determine outer boundaries of groups of contiguous pixels in each depth frame whose values are within a predetermined range of each other and to compute an average distance of all the pixels within the outer boundary of each of the objects and assign that average value distance to each of the pixels within the outer boundary.

6. The tracking system as claimed in claim 1 wherein the processing system executes program instructions to determine the distance to a top face of each of the objects from the rangefinder from the depth frames and to calculate a length and a width for each of the objects.

7. The tracking system as claimed in claim 6 wherein the processing system executes program instructions to:
a) calculate the length of each of the objects as the product of the length in the conveying direction of a plane containing the top face and the ratio of the number of pixels defining the length of the top of the object to the depth frame length in the conveying direction in pixels; and
b) calculate the width of each of the objects as the product of the width in the transverse direction perpendicular to the conveying direction of the plane containing the top face and the ratio of the number of pixels defining the width of the top of the object to the depth frame width perpendicular to the conveying direction in pixels.

8. The tracking system as claimed in claim 7 wherein the processing system executes program instructions to:
a) compute the length Pₓ in the conveying direction of the plane containing the top face of the object as Pₓ=(B/2)tan(αₓ), where B is the distance of the rangefinder from the top face of the object and αₓ is half the maximum sweep angle of the rangefinder in the conveying direction; and
b) compute the width P_{y} in the conveying transverse direction of the plane containing the top face of the object as P_{y}=(B/2)tan(α_{y}), where B is the distance of the rangefinder from the top face of the object and α_{y} is half the maximum sweep angle of the rangefinder in the transverse direction.

9. The tracking system as claimed in claim 1 wherein the processing system executes program instructions to compute the centroid of each of the objects and use the centroid as the selected tracking point to be tracked.

10. The tracking system as claimed in claim 1 wherein the one or more motion characteristics of the objects are selected from the group consisting of: component of object velocity or acceleration in the conveying direction; component of object velocity or acceleration perpendicular to the conveying direction; net acceleration of the object; trajectory angle of the object; and orientation of the object.

11. The tracking system as claimed in claim 10 wherein the conveyor is a conveyor belt and wherein the processing system executes program instructions to estimate the speed of the conveyor belt from the component of object velocity in the conveying direction.

12. A method for tracking objects, comprising:
conveying objects in a conveying direction on a conveying surface of a conveyor;
capturing, with a rangefinder, depth frames constituting an array of pixels whose values indicate the distance from the rangefinder to objects in a field of view encompassing a portion of the conveyor;
executing program instructions by a processing system to:
a) determine the position on the conveyor of a selected tracking point on each of the objects;
b) track the selected tracking point of each of the objects from depth frame to depth frame;
c) map the trajectory of each of the objects along the conveyor from the depth frames;
d) determine one or more motion characteristics of each of the objects from the trajectory.

13. The method as claimed in claim 12 comprising executing program instructions by the processing system to compensate the depth frame for tilt of the rangefinder with respect to the conveyor.

14. The method as claimed in claim 12 comprising executing program instructions by the processing system to determine outer boundaries of the objects after eroding and dilating the pixels in each depth frame.

15. The method as claimed in claim 12 comprising executing program instructions by the processing system to determine outer boundaries of groups of contiguous pixels in each depth frame whose values are within a predetermined range of each other, compute an average value of the values of all the pixels within the outer boundary of each of the objects, and assign that average value to each of the pixels within the outer boundary.

16. The method as claimed in claim 12 comprising executing program instructions by a processing system to determine the distance to a top face of each of the objects from the rangefinder from the depth frames and to calculate a length and a width for each of the objects.

17. The method as claimed in claim 12 comprising executing program instructions by a processing system to compute the centroid of each of the objects and use the centroid as the selected tracking point.

18. The method as claimed in claim 12 wherein the one or more motion characteristics of the objects are selected from the group consisting of: component of object velocity or acceleration in the conveying direction; component of object velocity or acceleration perpendicular to the conveying direction; net acceleration of the object; trajectory angle of the object; and orientation of the object.
